(19) United States
(12) Patent Application Publication
(10) Pub. No.: US 2011/0153262 A1
(43) Pub. Date: Jun. 23, 2011

(54) COLLISION DETECTION APPARATUS

(76) Inventors: Ayako Furuta, Tokyo (JP); Toshiyuki Yamashita, Tokyo (JP); Satoru Inoue, Tokyo (JP)

(21) Appl. No.: 13/061,390

(22) PCT Filed: Sep. 24, 2009
(86) PCT No.: PCT/JP2009/004817

§ 371 Date: Feb. 28, 2011

(30) Foreign Application Priority Data
Dec. 26, 2008 (JP) 2008-332848

(51) Int. Cl. G06F 15/00; G01P 15/00

(52) U.S. Cl. 702/141

(57) ABSTRACT

A collision detection apparatus includes: an acceleration acquisition processing unit 11 for acquiring an output of an acceleration sensor 2; a duration calculation unit 12 for calculating a duration from a time at which an acquired acceleration passes a preset, predetermined value to a time at which the acceleration passes the predetermined value again; and a collision determination processing unit 13 for performing a collision determination by comparing the acceleration acquired by the acceleration acquisition processing unit 11 with a threshold, wherein the collision determination processing unit 13 corrects a sensitivity of the collision determination in accordance with the duration calculated by the duration calculation unit 12.

### TECHNICAL FIELD

The present invention relates to a collision detection apparatus that performs a collision determination using an acceleration measured by an acceleration sensor and generates a signal for activating a collision protection device.

### BACKGROUND ART

Passenger protection devices (airbags) provided in the interior of a vehicle cabin, pedestrian protection devices provided on the exterior of the vehicle cabin, and so on are known as collision protection devices provided in a vehicle.

A passenger protection device protects passengers from an impact accompanying a vehicle collision by deploying airbags stored in front and rear seats of the vehicle during the collision, while a pedestrian protection device protects pedestrians during a vehicle collision by flipping up a hood or deploying an airbag onto the hood.

In a conventional technique employed in the collision protection devices described above, a frequency of vibration generated during the vehicle collision is specified by frequency-analyzing a signal indicated an acceleration detected by an acceleration sensor through fast Fourier transform, and an airbag deployment timing is calculated from a signal indicating the specified frequency (see Patent Document 1, for example).

In another conventional technique, in light of the fact that an output of an acceleration sensor for detecting an impact varies in accordance with variation in a rigidity of a vehicle body caused by temperature variation, a temperature sensor is disposed separately to the acceleration sensor and the output of the acceleration sensor is evaluated in accordance with the temperature detected by the temperature sensor (see Patent Document 2, for example). In a further conventional technique, a vibrating member is attached to a vehicle in order to identify a collision with a pedestrian on the basis of a hardness of a collision object, such as a human body, a traffic cone, a utility pole, and so on, and a determination as to whether or not the collision object is a human body is made in accordance with a vibration frequency of the vibrating member (see Patent Document 3, for example).

### PRIOR ART DOCUMENTS

### Patent Documents

Patent Document 1: Japanese Patent Application Publication No. H6-127332

Patent Document 2: Japanese Translation of PCT Application No. 2006-512245

Patent Document 3: Japanese Patent Application Publication No. 2007-55319

### SUMMARY OF THE INVENTION

With the technique disclosed in Patent Document 1, however, acceleration sensor outputs for several periods must be stored in a memory in order to implement the fast Fourier transform, and therefore an expensive microcomputer having a large memory capacity must be used. Furthermore, a processing speed decreases due to the calculation complexity, leading to a delay in the timing of the collision determination.

Further, with the technique disclosed in Patent Document 2, a device for measuring rigidity parameters of the collision object, such as a temperature sensor, is required in addition to the acceleration sensor, leading to cost-related problems. With the technique disclosed in Patent Document 3, since the hardness of the vehicle body varies depending on temperatures, the frequency of the collision detection sensor output varies in relation to an identical collision object, and as a result, malfunctions occur such that airbag activation cannot be switched ON when the vehicle collides with a human body at a low temperature, airbag activation is switched ON when the vehicle collides with a utility pole or the like at a high temperature, and so on.

The present invention has been designed to solve the problems described above, and an object thereof is to provide a collision detection apparatus with which cost-related problems can be solved, a delay in a collision determination timing can be eliminated, and a collision can be determined with a high degree of reliability.

In order to achieve the object described above, a collision detection apparatus according to the present invention includes: an acceleration acquisition processing unit for acquiring an acceleration sensor output; a duration calculation unit for calculating a duration from a time at which an acquired acceleration passes a preset, predetermined value to a time at which the acceleration passes the predetermined value again; and a collision determination processing unit for performing a collision determination by comparing the acceleration acquired by the acceleration acquisition processing unit with a threshold, wherein the collision determination processing unit corrects a sensitivity of the collision determination in accordance with the duration calculated by the duration calculation unit.

According to the present invention, a collision detection apparatus with which cost-related problems can be solved, a delay in a collision determination timing can be eliminated, and a collision can be determined with a high degree of reliability can be provided.

### BRIEF DESCRIPTION OF THE DRAWINGS

FIG. 1 is a view showing an example in which a pedestrian protection device employing a collision detection apparatus in accordance with a first embodiment of the present invention is applied to a vehicle;

FIG. 2 is a block diagram showing the constitution of the collision detection apparatus in accordance with the first embodiment of the present invention;

FIG. 3 is a flowchart showing a basic operation of the collision detection apparatus in accordance with the first embodiment of the present invention;

FIG. 4 is a flowchart showing a detailed operation of the collision detection apparatus in accordance with the first embodiment of the present invention;

FIG. 5 is a flowchart showing an example of sensitivity correction processing in the detailed operation of the collision detection apparatus in accordance with the first embodiment of the present invention;

FIG. 6 is a view showing an example of a threshold map used by the collision detection apparatus in accordance with the first embodiment of the present invention;

FIG. 7 is a concept diagram showing the detailed operation of the collision detection apparatus in accordance with the first embodiment of the present invention on a temporal axis;

FIG. 8 is a flowchart showing another example of the sensitivity correction processing in the detailed operation of the collision detection apparatus in accordance with the first embodiment of the present invention;

FIG. 9 is a view showing an example of a G correction coefficient map used by the collision detection apparatus in accordance with the first embodiment of the present invention;

FIG. 10 is a view showing an example of a threshold and G correction coefficient map used by the collision detection apparatus in accordance with the first embodiment of the present invention;

FIG. 11 is a view showing another example of the threshold and G correction coefficient map used by the collision detection apparatus in accordance with the first embodiment of the present invention;

FIG. 12 is a view showing a further example of the threshold and G correction coefficient map used by the collision detection apparatus in accordance with the first embodiment of the present invention;

FIG. 13 is a flowchart showing a detailed operation of a collision detection apparatus in accordance with a second embodiment of the present invention;

FIG. 14 is a concept diagram showing the detailed operation of the collision detection apparatus in accordance with the second embodiment of the present invention on a temporal axis; and

FIG. 15 is a concept diagram showing an exceptional processing operation of the collision detection apparatus in accordance with the second embodiment of the present invention on a temporal axis.

### BEST MODE FOR CARRYING OUT THE INVENTION

Embodiments of the present invention for illustrating the present invention in further detail will be described below with reference to the attached drawings.

### First Embodiment

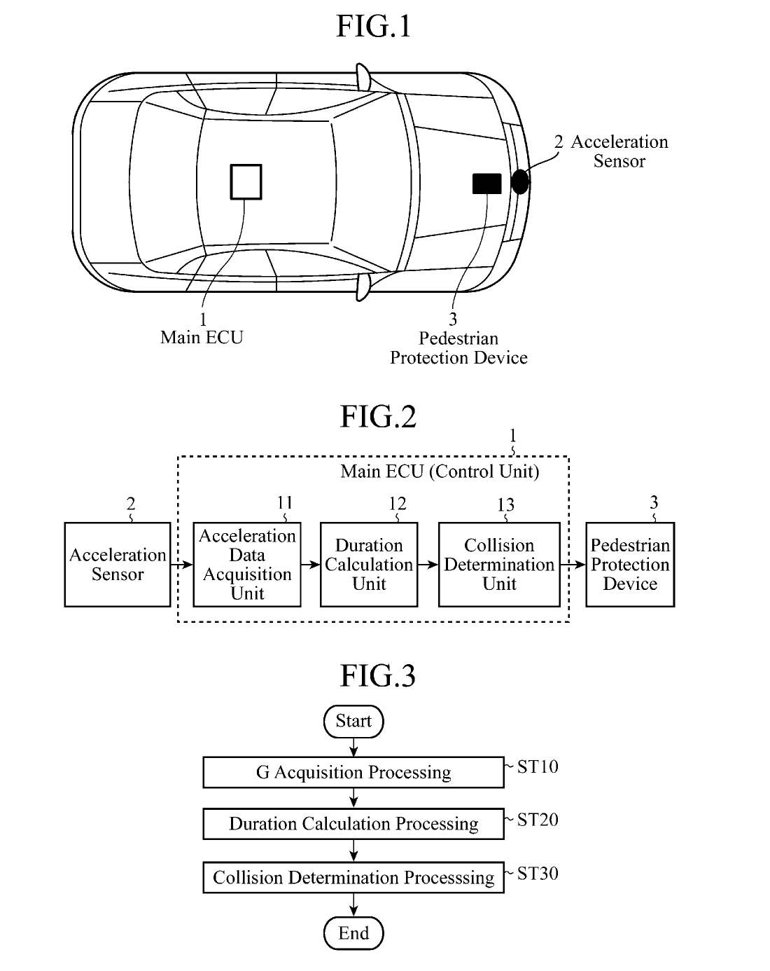

FIG. 1 is a view showing an example in which a collision protection device employing a collision detection apparatus in accordance with a first embodiment of the present invention is applied to a vehicle.

As shown in FIG. 1, the collision protection device is constituted by a main ECU 1 (a control unit) disposed in a substantially central portion of a vehicle, an acceleration sensor 2 disposed at a front of the vehicle, and a pedestrian protection device 3 installed in a hood part of the vehicle in order to alleviate an impact on a pedestrian when the pedestrian and the vehicle collide. The pedestrian protection device 3 is an airbag that deploys toward an outer side of the vehicle or a device that pushes up the hood part or a bumper part of the vehicle.

A microcomputer is installed in the main ECU 1, and by successively reading and executing a program recorded in an inbuilt memory, the microcomputer executes functions of the control unit for acquiring an output of the acceleration sensor 2 attached to the front of the vehicle, performing a collision determination by correcting a sensitivity of the acceleration sensor 2 from a time series of the acquired output of the acceleration sensor 2, for example a half period G, and activating the pedestrian protection device 3.

However, though only the main ECU 1 is shown herein as an electronic control unit, sub-ECUs (not depicted) for controlling an engine or electric equipment systems including air-conditioning are additionally disposed in various parts of the vehicle, and the respective ECUs are connected by a bus of a CAN (Control Area Network), which is a serial communication protocol standardized by the International Organization for Standardization (ISO).

FIG. 2 is a block diagram showing the constitution of the collision detection apparatus in accordance with the first embodiment of the present invention, and more specifically showing a functional layout of a program structure of the main ECU 1 shown in FIG. 1.

As shown in FIG. 2, the program executed by the main ECU 1 (the control unit) includes an acceleration data acquisition unit 11 (an acceleration acquisition processing unit), a duration calculation unit 12, and a collision determination unit 13 (a collision determination processing unit).

The acceleration data acquisition unit 11 has a function for acquiring the output of the acceleration sensor 2 and transferring the acquired output to the duration calculation unit 12.

The duration calculation unit 12 calculates a half period length of a waveform from the acquired acceleration output of the acceleration sensor 2 and transfers the calculated half period length to the collision determination unit 13. The collision determination unit 13 has functions for correcting a threshold of a signal for activating the pedestrian protection device 3 on the basis of a duration calculated by the duration calculation unit 12, performing a collision determination by comparing the corrected threshold with the output of the acceleration sensor 2, and activating the pedestrian protection device 3 by transmitting a signal to the pedestrian protection device 3. The respective function blocks 11, 12, 13 described above will be described in detail below.

FIG. 3 is a flowchart showing a basic operation of the collision detection apparatus in accordance with the first embodiment of the present invention.

A basic operation of the collision detection apparatus in accordance with the first embodiment of the present invention, shown in FIG. 2, will be described below with reference to the flowchart shown in FIG. 3.

First, the main ECU 1 executes G acquisition processing in which the acceleration data acquisition unit 11 acquires an acceleration data G from the acceleration sensor 2 disposed at the front of the vehicle and transfers the acquired acceleration data G to the duration calculation unit 12 (step ST10). Upon reception of the acceleration data G, the duration calculation unit 12 executes duration calculation processing for calculating a half period length of an acceleration waveform transferred by the acceleration data acquisition unit 11 and transferring the calculated half period length to the collision determination unit 13 (step ST20).

Next, the collision determination unit 13 executes collision determination processing for performing a collision determination by correcting a threshold in accordance with the half period length calculated by the duration calculation unit 12, determining a maximum acceleration G within the half period, and comparing the maximum acceleration G with the corrected threshold, and activating the pedestrian protection device 3 by transmitting an activation signal thereto when the maximum acceleration G exceeds the threshold (step ST30).

The collision determination unit 13 corrects the threshold on the basis of the half period length of the acceleration waveform calculated by the duration calculation unit 12 such that the threshold is increased when the half period length is short and reduced when the half period is long. The collision determination unit 13 implements the collision determination in accordance with the corrected threshold such that when the collision is determined to exceed the threshold, the activation signal is transmitted to the pedestrian protection device 3. This will be described in detail below.

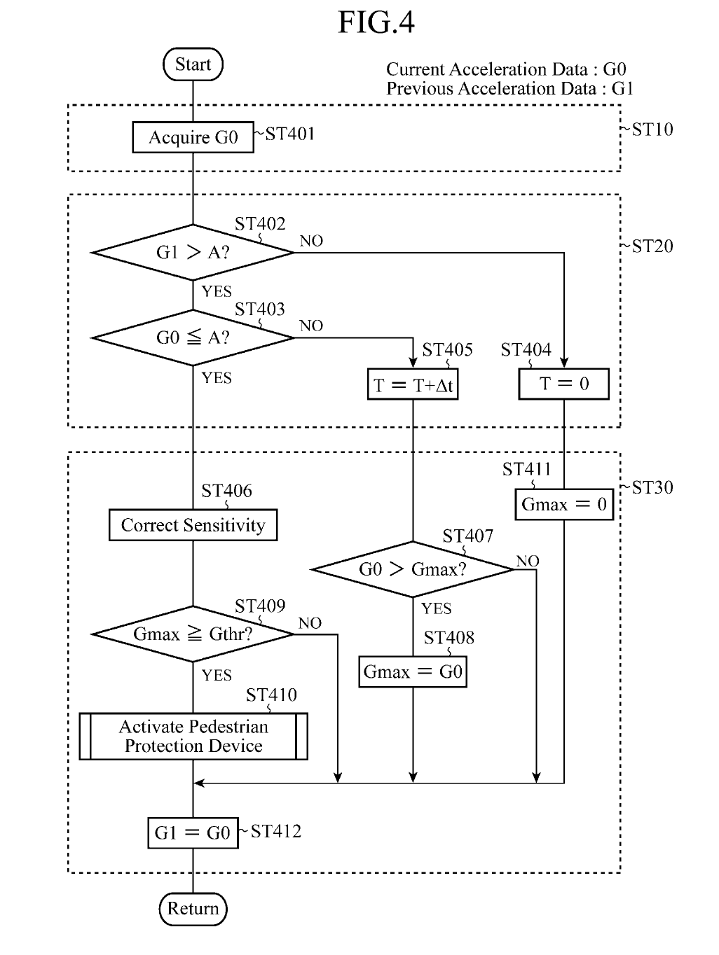

FIG. 4 is a flowchart showing a detailed operation of the collision detection apparatus in accordance with the first embodiment of the present invention.

A detailed operation of the collision detection apparatus in accordance with the first embodiment of the present invention as shown in FIG. 2 will be described below with reference to the flowchart as shown in FIG. 4.

First, the acceleration data acquisition unit 11 acquires acceleration data G0 (to be referred to hereafter as current acceleration data) relating to a current time from the acceleration sensor 2 and transfers the acquired acceleration data G0 to the duration calculation unit 12 (step ST401). Having received the acceleration data G0, the duration calculation unit 12 compares acceleration data G1 (hereinafter, to be referred to as previous acceleration data) acquired immediately previously with a preset threshold A (step ST402).

When the previous acceleration data G1 are equal to or smaller than the threshold A (“NO” in step ST402), the duration calculation unit 12 sets a half period length T at 0 (step ST404), sets a maximum value Gmax at 0 (step ST411), and updates the previous acceleration data G1 to the current data G0 (step ST412).

On the other hand, when the previous acceleration data G1 are larger than the threshold A (“YES” in step ST402), the duration calculation unit 12 compares the current acceleration data G0 with the threshold A (step ST403).

When the current acceleration data G0 are equal to or smaller than the threshold A (“YES” in step ST403), sensitivity correction processing is executed by the collision determination unit 13 (step ST406). The sensitivity correction processing will be described below using a flowchart shown in FIG. 5.

When the current acceleration data G0 are larger than the threshold A (“NO” in step ST403), on the other hand, the duration calculation unit 12 adds a sampling interval Δt to the half period length T and then hands control over to the collision determination unit 13 (step ST405). In other words, the duration calculation unit 12 calculates a time interval extending from a time at which the acceleration serving as the output of the acceleration sensor 2 acquired by the acceleration data acquisition unit 11 exceeds the threshold A to a time at which the output falls to or below the threshold A as the half period length and transfers the calculated half period length to the collision determination unit 13.

Next, the collision determination unit 13 compares the current acceleration data G0 with the maximum value Gmax of the acceleration data up to a previous time (step ST407).

When the current acceleration data G0 are larger than the maximum value Gmax of the acceleration data up to the previous time (“YES” in step ST407), the maximum value Gmax is updated to the current acceleration data G0, the result is stored in the inbuilt memory (step ST408), and the previous acceleration data G1 are updated to the current acceleration data G0 (step ST412). When the current acceleration data G0 are equal to or smaller than the maximum value Gmax (“NO” in step ST407), on the other hand, the previous acceleration data G1 are updated to the current acceleration data G0 (step ST412).

After performing sensitivity correction using the maximum value Gmax and the value of the half period length T (step ST406), as will be described below, the collision determination unit 13 compares a sensitivity-corrected threshold Gthr with the maximum value Gmax of the acceleration data up to the previous time (step ST409). When the maximum value Gmax is smaller than the corrected threshold Gthr (“NO” in step ST409), the previous acceleration data G1 are updated to the current acceleration data G0, whereupon the control is returned to the G0 acquisition processing of the step ST401 (step ST412) and the processing of the steps ST401 to ST412 described above is repeated.

On the other hand, when the maximum value Gmax is larger than the corrected threshold Gthr (“YES” in step ST409), the pedestrian protection device 3 is activated (step ST410) and the previous acceleration data G1 are updated to the current acceleration data G0 (step ST412). The control is then returned to the G0 acquisition processing of the step ST401, whereupon the processing of the steps ST401 to ST412 described above is repeated.

Note that the processing of the step ST401, the processing of the steps ST402 to ST405, and the processing of the steps ST406 to ST410 described above correspond respectively to the step ST10, the step ST20, and the step ST30 of the basic operation shown in FIG. 3.

FIG. 5 is a flowchart showing detailed procedures of the sensitivity correction processing (step ST406) as shown in the flowchart of FIG. 4.

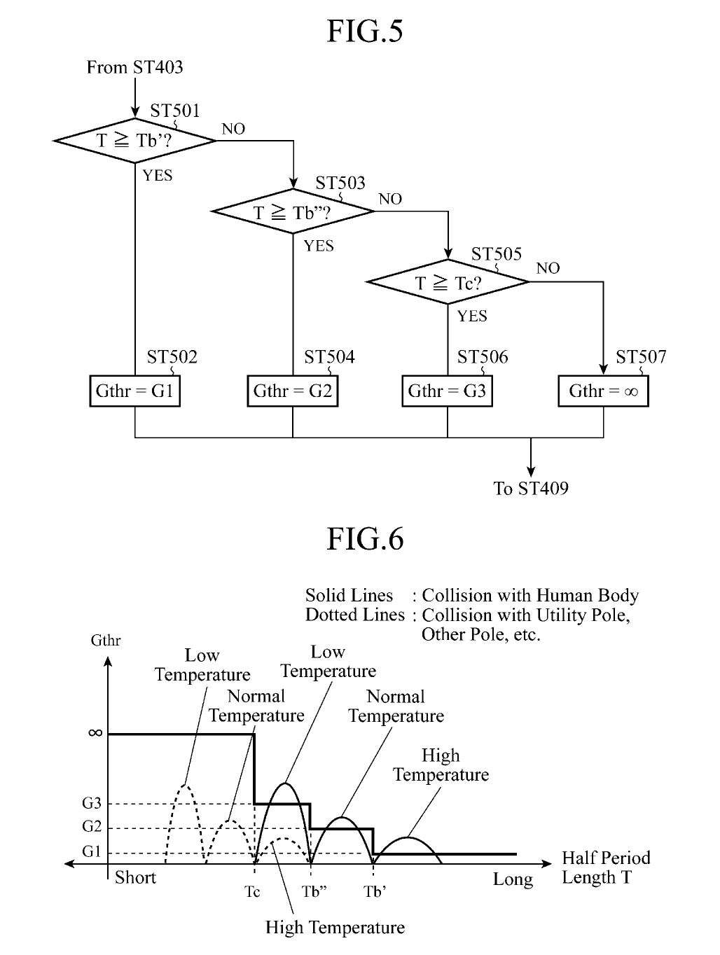

An operation of the collision determination unit 13 will be described below with reference to the flowchart as shown in FIG. 5, but first, relationships between the half period length T and the threshold Gthr corresponding to differences in the hardness of a collision object will be described with reference to a threshold map as shown in FIG. 6.

FIG. 6 illustrates acceleration generated by a collision with the vehicle, in which the abscissa shows the half period length T and the ordinate shows a G level. In FIG. 6, solid lines indicate a case in which the collision object is a human body and dotted lines indicate a case in which the collision object is a utility pole or another pole.

As shown in FIG. 6, the half period length T and the G level differ depending on an outside air temperature environment (a low temperature, a normal temperature, a high temperature), even when collision object remains the same, and therefore, when the collision determination is performed at a fixed sensitivity, a human body cannot be differentiated from an electric pole, another pole, and so on.

Hence, in this embodiment, the sensitivity is corrected by correcting the threshold Gthr according to three patterns, namely a collision with a human body at a low temperature (a region in which the half period length T is between Tc and Tb″), a collision with a human body at a normal temperature (a region in which the half period length T is between Tb″ and Tb′), and a collision with a human body at a high temperature (a region in which the half period length T is greater than Tb′). Note that a region in which the half period length T is shorter than Tc is a region in which the collision is not with a human body, and therefore the threshold is set at ∞ (a finite value that cannot occur in reality).

More specifically, in the flowchart of FIG. 5, the collision determination unit 13 acquires the half period length T from the duration calculation unit 12 and determines whether or not the half period length T is equal to or greater than Tb′ (step ST501). When the half period length T is equal to or greater than Tb′ (“YES” in step ST501), the collision determination unit 13 corrects the threshold Gthr to G1 (step ST502), and when the half period length T is smaller than Tb′ (“NO” in step ST501), the collision determination unit 13 determines whether or not the half period length T is equal to or greater than Tb″ (step ST503).

When the half period length T is equal to or greater than Tb″ (“YES” in step ST503), the collision determination unit 13 corrects the threshold Gthr to G2 (step ST504), and when the half period length T is smaller than Tb″ (“NO” in step ST503), the collision determination unit 13 determines whether or not the half period length T is equal to or greater than Tc (step ST505).

When the half period length T is equal to or greater than Tc, including Tc (“YES” in step ST505), the collision determination unit 13 corrects the threshold Gthr to G3 (step ST506), and when the half period length T is smaller than Tc (“NO” in step ST505), the collision determination unit 13 corrects the threshold Gthr to ∞ (step S507). Note that G1<G2<G3.

In other words, in a region where the half period length T is within a range extending from a first value (Tc) to a second value (Tb″), which indicates a collision with a human body at a low temperature, the collision determination unit 13 corrects the threshold Gthr to a first threshold (G3), in a region where the half period length T is within a range extending from the second value (Tb″) to a third value (Tb′), which indicates a collision with a human body at a normal temperature, the collision determination unit 13 corrects the threshold Gthr to a second threshold (G2), which is shorter than the first threshold (G3), and in a region where the half period length T is equal to or greater than the third value (Tb′), which indicates a collision with a human body at a high temperature, the collision determination unit 13 corrects the threshold Gthr to a third threshold (G1), which is shorter than the second threshold (G2).

Note that in a region where the half period length T is shorter than the first value (Tc), the collision is not with a human body, and therefore the threshold is set at ∞ (a finite value that cannot occur in reality).

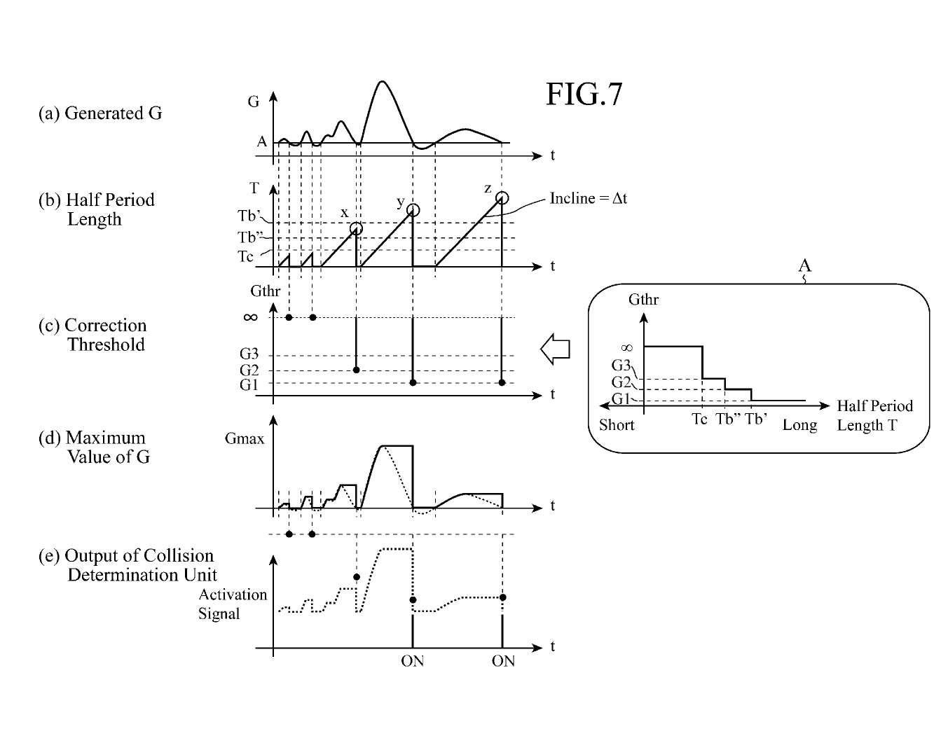

FIG. 7 is a concept diagram showing the operation of the collision detection apparatus in accordance with the first embodiment of the present invention on a temporal axis, in which (a) illustrates the output of the acceleration sensor 2 (the generated G), (b) illustrates the output of the duration calculation unit 12 (the half period length), (c) illustrates the corrected threshold Gthr, (d) illustrates the maximum value Gmax of the generated G, and (e) illustrates the output of the collision determination unit 13. Supplementary description of the operation performed by the collision detection apparatus in accordance with the first embodiment of the present invention will be provided below with reference to the concept diagram as shown in FIG. 7.

In the concept diagram of FIG. 7, a waveform shown in (a) indicates the generated G, i.e. the output of the acceleration sensor 2, which is acquired by the acceleration data acquisition unit 11 and transferred to the duration calculation unit 12.

Further, a waveform shown in (b) indicates the half period length of the generated G, which is calculated by the duration calculation unit 12 as a time interval extending from a time at which the generated G, which serves as the output of the acceleration sensor 2 acquired by the acceleration data acquisition unit 11, exceeds a predetermined value A including 0 to a time at which the generated G falls to or below the predetermined value A, as shown in the step ST20 of FIG. 3 or the steps ST402 to ST405 of FIG. 4. Here, triangular waves having an incline or gradient Δt respectively indicate the half period.

As described above, the collision determination unit 13 performs sensitivity correction in accordance with the procedures illustrated in the step ST406 of FIG. 4 and the steps ST501 to ST507 of FIG. 5.

In (c), the collision determination unit 13 corrects the threshold using a preset threshold map a of the half period and the threshold, shown in FIG. 6, and the half period length calculated by the duration calculation unit 12. More specifically, the collision determination unit 13 corrects the threshold Gthr to G2 in a region x where the half period length T exceeds Tb″ and corrects the threshold Gthr to G1 in two regions y, z where the half period length T exceeds Tb′.

Meanwhile, as illustrated in the steps ST405, ST407 and ST408 of FIG. 4, the collision determination unit 13 compares the current acceleration data G0 with the maximum value Gmax of the acceleration data up to the previous time at each sampling interval, updates the maximum value Gmax successively in accordance with the comparison result, and stores the updated maximum value Gmax in the inbuilt memory. Here, (d) shows a waveform of transitions of the maximum value Gmax with the lapse of time. Next, as illustrated in the steps ST409 and ST410 of FIG. 4, the collision determination unit 13 compares the sensitivity-corrected threshold Gthr with the maximum value Gmax of the acceleration data up to the previous time and activates the pedestrian protection device 3 when the maximum value Gmax is larger than the corrected threshold Gthr. In other words, as shown by a waveform of the signal (the activation signal) for activating the pedestrian protection device 3 in (e), the collision determination unit 13 compares the waveform of the maximum value Gmax shown in (d) with the corrected threshold shown in (c), and outputs an ON signal to the pedestrian protection device 3 when the maximum value Gmax is larger than the threshold Gthr.

With the collision detection apparatus in accordance with the first embodiment of the present invention, described above, the half period length T of the acquired output of the acceleration sensor 2 is calculated, and the collision determination is made in accordance with the calculated half period length T. In so doing, the processing is simplified and only a small memory is required, and therefore a high-performance microprocessor is not required. As a result, the collision detection apparatus can be constructed with an inexpensive constitution. Further, since the sensitivity is corrected in accordance with the half period length T of the output of the acceleration sensor 2, the collision determination can be made with a high degree of reliability without being affected by the external air temperature and so on. Moreover, the pedestrian protection device 3 can be activated without a timing delay.

Note that in the collision detection apparatus in accordance with the first embodiment of the present invention, the collision determination unit 13 performs sensitivity correction on the acceleration sensor 2 by correcting the threshold, but similar effects are obtained when the sensitivity correction is performed by correcting a gain of the acceleration instead of the threshold.

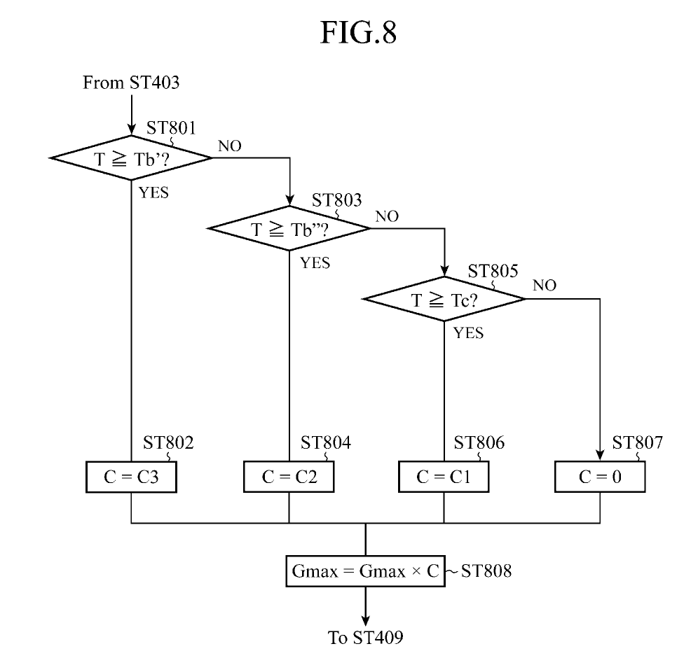

In this case, a gain correction coefficient (hereinafter, to be referred to as a G correction coefficient) must be multiplied by the maximum value Gmax and then compared with a fixed threshold in order to control the gain of the acceleration. Detailed procedures of the sensitivity correction processing (step ST406 of FIG. 4) in this case are shown in FIG. 8.

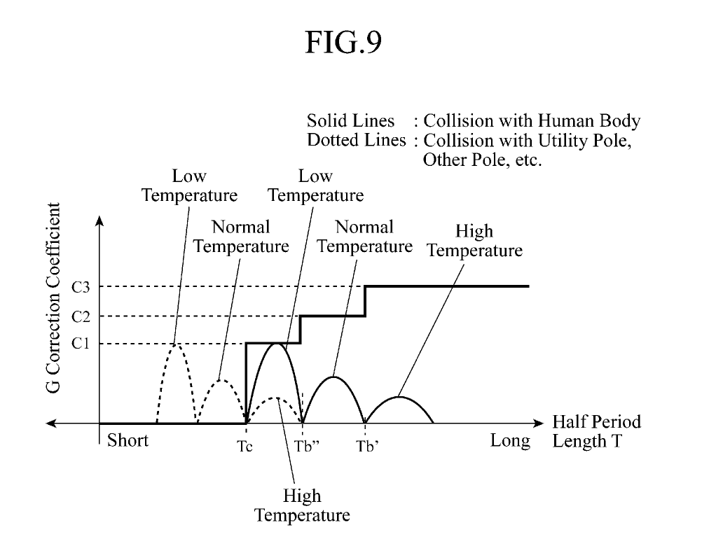

FIG. 9 is a G correction coefficient map showing the half period length T on the abscissa and the G correction coefficient of the acceleration on the ordinate. In FIG. 9, solid lines indicate a case in which the collision object is a human body and dotted lines indicate a case in which the collision object is a utility pole or another pole.

As shown on the G correction coefficient map of FIG. 9, the half period length T and the G correction coefficient differ depending on the outside air temperature environment (a low temperature, a normal temperature, a high temperature), even when the collision object remains the same, and therefore, when the collision determination is performed at a fixed sensitivity, a human body cannot be differentiated from an electric pole, another pole, and so on. Hence, in this case, the sensitivity is corrected by modifying the G correction coefficient according to three patterns, namely a collision with a human body at a low temperature (a region in which the half period length T is between Tc and Tb″), a collision with a human body at a normal temperature (a region in which the half period length T is between Tb″ and Tb′), and a collision with a human body at a high temperature (a region in which the half period length T is greater than Tb′).

More specifically, in the flowchart of FIG. 8, the collision determination unit 13 acquires the half period length T from the duration calculation unit 12 and determines whether or not the half period length T is equal to or greater than Tb′ (step ST801).

When the half period length T is equal to or greater than Tb′ (“YES” in step ST801), the collision determination unit 13 sets the G correction coefficient at C3 (step ST802), and when the half period length T is shorter than Tb′ (“NO” in step ST801), the collision determination unit 13 determines whether or not the half period length T is equal to or greater than Tb″ (step ST803).

When the half period length T is equal to or greater than Tb″ (“YES” in step ST803), the collision determination unit 13 sets the G correction coefficient at C2 (step ST804), and when the half period length T is shorter than Tb″ (“NO” in step ST803), the collision determination unit 13 determines whether or not the half period length T is equal to or greater than Tc (step ST805).

When the half period length T is equal to or greater than Tc (“YES” in step ST805), the collision determination unit 13 sets the G correction coefficient at C1 (step ST806), and when the half period length T is shorter than Tc (“NO” in step ST805), the collision determination unit 13 sets the G correction coefficient at 0 such that the gain correction is not performed on the acceleration (step S807). Note that here, the G correction coefficient is set such that C1<C2<C3.

In other words, in the region where the half period length T is within a range extending from the first value (Tc) to the second value (Tb″), which indicates a collision with a human body at a low temperature, the collision determination unit 13 corrects the G correction coefficient to a first G correction coefficient (C1), in the region where the half period length T is within a range extending from the second value (Tb″) to the third value (Tb′), which indicates a collision with a human body at a normal temperature, the collision determination unit 13 corrects the G correction coefficient to a second G correction coefficient (C2), which is larger than the first G correction coefficient (C1), and in the region where the half period length T is equal to or greater than the third value (Tb′), which indicates a collision with a human body at a high temperature, the collision determination unit 13 corrects the G correction coefficient to a third G correction coefficient (C3), which is larger than the second G correction coefficient (C2).

After correcting the G correction coefficient in accordance with the half period length T as described above, the collision determination unit 13 multiplies the corrected G correction coefficient by the maximum value Gmax (step ST808) and then advances to the processing for comparing the maximum value Gmax with the threshold in the step ST409 of FIG. 4.

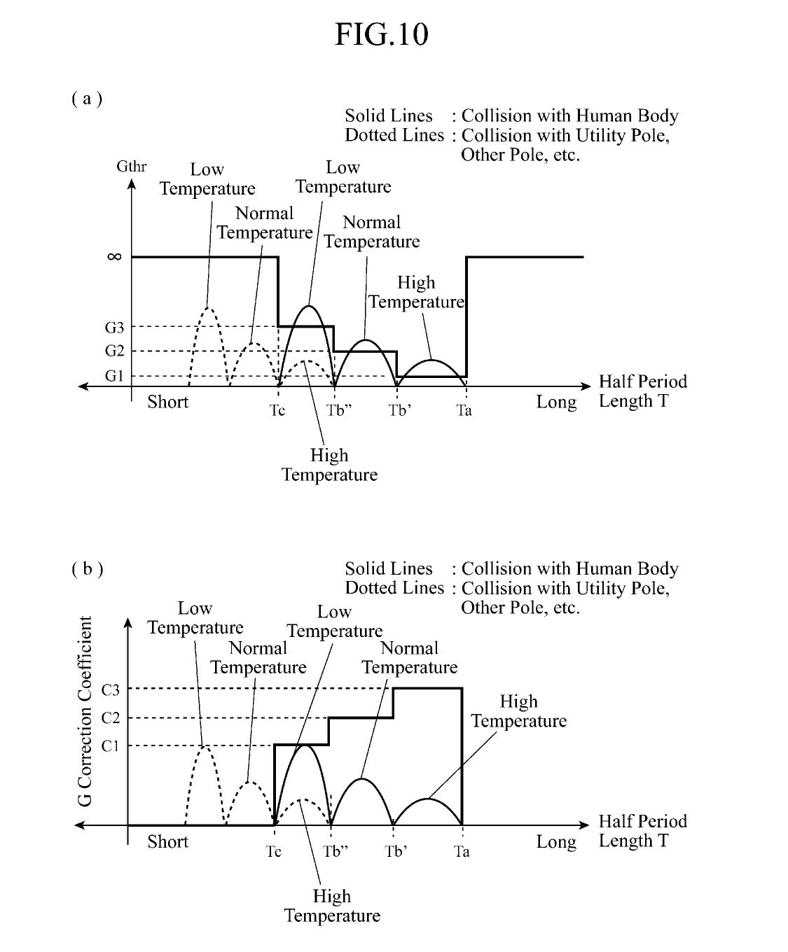

Note that although the threshold map shown in FIG. 6 is used with the collision detection apparatus in accordance with the first embodiment of the present invention, the content of the threshold map is not limited to that of FIG. 6, and as shown in FIG. 10(a), for example, a threshold map on which the threshold is corrected to ∞ in a region where the half period length exceeds Ta, which is longer than Tb′, may be used instead. Further, the content of the G correction coefficient map is not limited to that of FIG. 9, and as shown in FIG. 10(b), for example, a threshold map on which the G correction coefficient is corrected to C3 in a region where the half period length is between Tb′ and Ta and corrected to 0 in the region where the half period length exceeds Ta may be used instead.

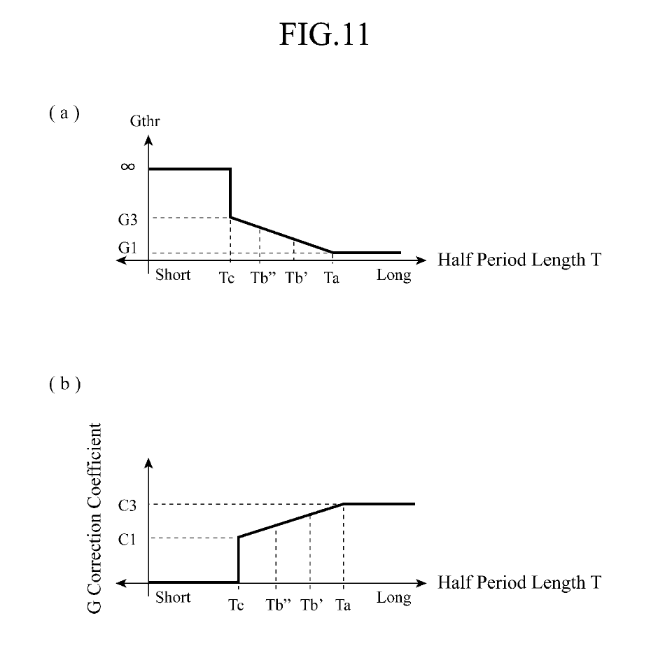

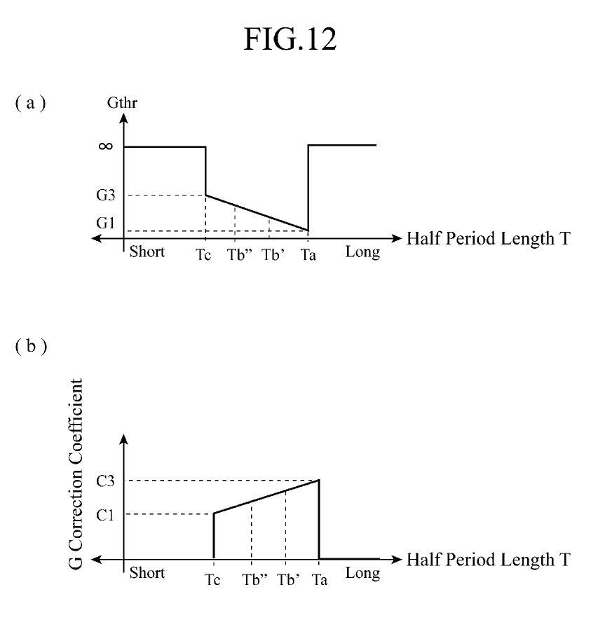

Further, as shown in FIGS. 11(a) and 11(b) or FIGS. 12(a) and 12(b), the threshold Gthr or the G correction coefficient may be varied continuously in accordance with the half period length T rather than in stages in a section extending from Tc to Ta.

Furthermore, in the collision detection apparatus in accordance with the first embodiment of the present invention, a positive direction half period is used to calculate the half period length T, but similar effects are obtained when a negative direction half period is used. In this case, the collision determination is made by comparing the corrected threshold or G correction coefficient with a minimum value Gmin of the acceleration G instead of the maximum value Gmax.

### Second Embodiment

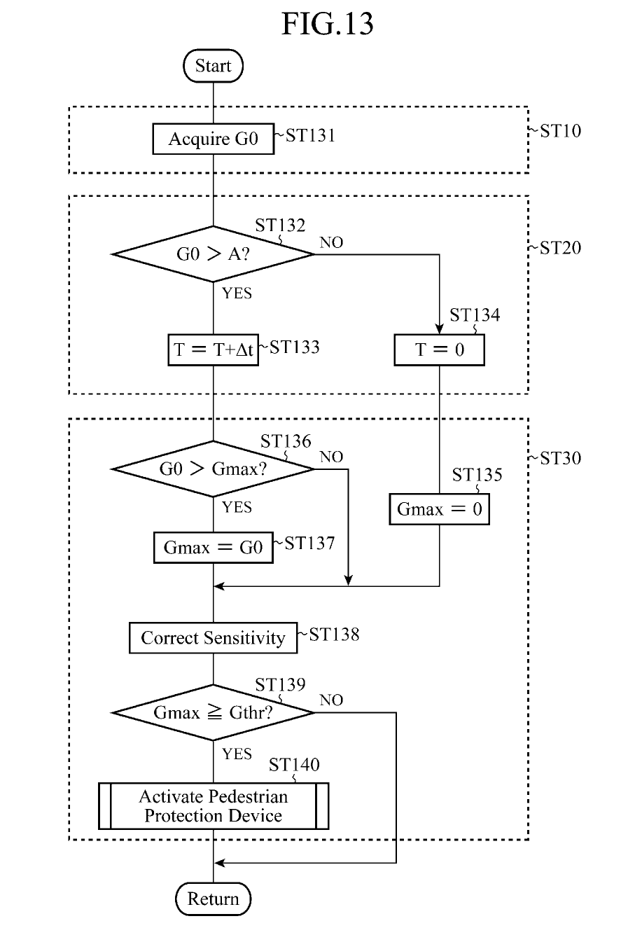

FIG. 13 is a flowchart showing a detailed operation of a collision detection apparatus in accordance with a second embodiment of the present invention.

In the second embodiment to be described below, similarly to the first embodiment described above, the collision detection apparatus is installed in the vehicle shown in FIG. 1, has the constitution shown in FIG. 2, and executes the basic operation shown in FIG. 3. However, whereas in the first embodiment the collision determination is made after waiting for the half period length T to be calculated, in the second embodiment the collision determination is made without waiting for the half period length T to be calculated (without storing the previous acceleration data) by comparing the current acceleration data G0 with the corrected threshold Gthr successively when the current acceleration data G0 exceeds the predetermined value A. As a result, an improvement in responsiveness can be achieved in comparison with the first embodiment. This point will be described in detail below.

In the flowchart of FIG. 13, the acceleration data acquisition unit 11 acquires the current acceleration data G0 from the acceleration sensor 2 and transfers the acquired current acceleration data G0 to the duration calculation unit 12 (step ST131).

Upon reception of the current acceleration data G0, the duration calculation unit 12 compares the current acceleration data G0 acquired from the acceleration data acquisition unit 11 with the preset, predetermined value A (step ST132). When the current acceleration data G0 are larger than the predetermined value A (“YES” in step ST132), the sampling interval Δt is added to the half period length T (here, 0) (step ST133), and when the current acceleration data G0 are smaller than the predetermined value A (“NO” in step ST132), the duration calculation unit 12 sets the half period length T at 0 and hands control over to the collision determination unit 13 (step ST134).

The collision determination unit 13 performs sensitivity correction by setting the maximum value Gmax at 0 on the basis of the half period length T=0 transferred from the duration calculation unit 12 (steps ST135, ST138).

Further, the collision determination unit 13 compares the current acceleration data G0 transferred from the duration calculation unit 12 with the maximum value Gmax up to the previous time (step ST136), and when the current acceleration data G0 are larger than Gmax (“YES” in step ST136), the collision determination unit 13 updates the maximum value Gmax to the current acceleration data G0 (step ST137) and performs sensitivity correction based on the updated maximum value Gmax and the value of the half period length T in accordance with the procedures shown in FIG. 5 and described in the first embodiment (step ST138). Next, the collision determination unit 13 compares the sensitivity-corrected threshold Gthr with the maximum value Gmax (step ST139), and when the maximum value Gmax is larger than the threshold Gthr (“YES” in step ST139), activates the pedestrian protection device 3 (step ST140). In other words, the collision determination is made without waiting for calculation of the half period length T, whereupon the operations of the step ST131 to ST140 are executed repeatedly.

Note that the G correction coefficient may be used in the sensitivity correction instead of the threshold Gthr, similarly to the first embodiment. In this case, the sensitivity correction is performed on the basis of the procedures shown in FIG. 8.

Further, the processing of the step ST131, the processing of the steps ST132 to ST134, and the processing of the steps ST135 to ST140 described above correspond respectively to the step ST10, the step ST20, and the step ST30 of the basic operation shown in FIG. 3.

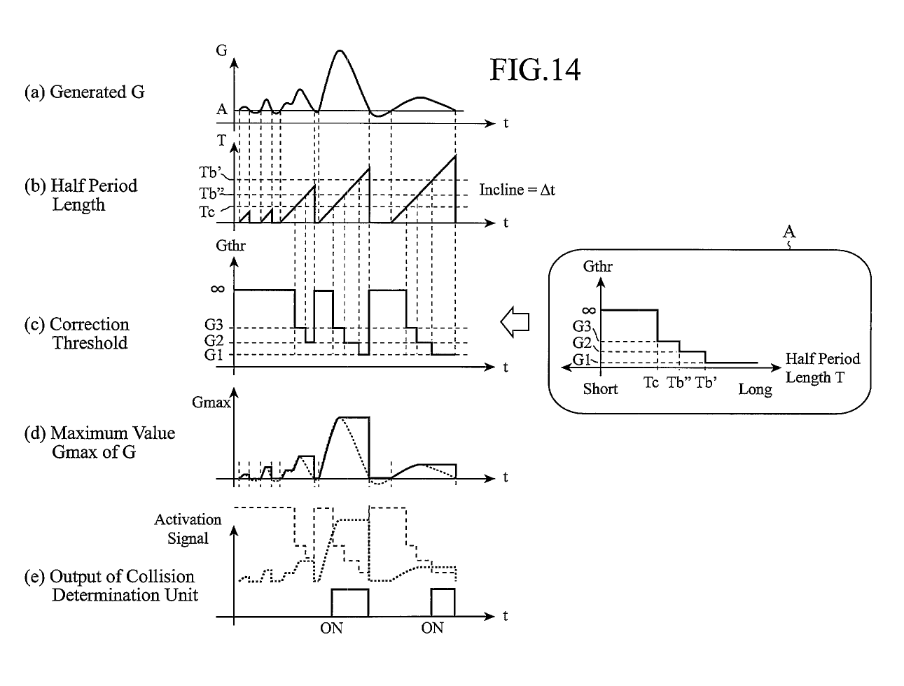

FIG. 14 is a concept diagram showing the operation of the collision detection apparatus in accordance with the second embodiment of the present invention on a temporal axis, in which (a) illustrates the G output of the acceleration sensor 2 (the generated G), (b) illustrates the output of the duration calculation unit 12, (c) illustrates the corrected threshold, (d) illustrates the maximum value Gmax of the generated G, and (e) illustrates the output of the collision determination unit 13.

Supplementary description of the operation performed by the collision detection apparatus in accordance with the second embodiment of the present invention will be provided below with reference to the concept diagram as shown in FIG. 14.

In the concept diagram of FIG. 14, a waveform shown in (a) indicates the generated G, i.e. the output of the acceleration sensor 2, which is acquired by the acceleration data acquisition unit 11 and transferred to the duration calculation unit 12. A waveform shown in (b) indicates the half period length of the generated G, which is calculated by the duration calculation unit 12 as a time interval obtained by adding the sampling interval Δt to the half period length T when the current generated G serving as the output of the acceleration sensor 2 acquired by the acceleration data acquisition unit 11 exceeds the predetermined value A, as shown in the step ST20 of FIG. 3 or the steps ST132 to ST134 of FIG. 13.

As described above, the collision determination unit 13 performs sensitivity correction in accordance with the procedures illustrated in the step ST138 of FIG. 13 or the steps ST501 to ST507 of FIG. 5 and the steps ST801 to ST808 of FIG. 8.

In (c), the collision determination unit 13 corrects the threshold Gthr using the preset threshold map a shown in FIG. 6 and the time interval calculated by the duration calculation unit 12. More specifically, the collision determination unit 13 corrects the threshold Gthr to ∞ in a region where the current acceleration data G0 are equal to or smaller than Tc, corrects the threshold Gthr to G3 in a region where the current acceleration data G0 are in a range exceeding Tc but not exceeding Tb″, corrects the threshold Gthr to G2 in a region where the current acceleration data G0 are within a range of Tb″ to Tb′, and corrects the threshold Gthr to G1 in a region where the current acceleration data G0 exceed Tb′.

Meanwhile, as shown in the steps ST135 to ST137 in FIG. 13, the collision determination unit 13 compares the current acceleration data G0 with the maximum value Gmax of the acceleration data up to the previous time, updates the maximum value Gmax successively in accordance with the comparison result, and stores the updated maximum value Gmax in the inbuilt memory. Here, (d) shows transitions of the maximum value Gmax with the lapse of time.

Next, as shown in the steps ST139 and ST140 of FIG. 13, the collision determination unit 13 compares the sensitivity-corrected threshold Gthr with the maximum value Gmax up to the previous time, and activates the pedestrian protection device 3 when the maximum value Gmax is larger than the corrected threshold Gthr. In other words, as shown by the waveform of the signal for activating the pedestrian protection device 3 in (e), the collision determination unit 13 compares the waveform of the maximum value Gmax shown in (d) with the corrected threshold shown in (c), and outputs an ON signal to the pedestrian protection device 3 when the maximum value Gmax is larger than the threshold Gthr.

In the collision detection apparatus in accordance with the second embodiment of the present invention, described above, the control unit (the main ECU 1) performs successive collision determinations without storing the previous acceleration output by the acceleration sensor 2 by comparing the maximum value of the output of the acceleration sensor 2 with the corrected threshold or a value obtained by multiplying the G correction coefficient by the maximum value from the time at which the current acceleration exceeds the predetermined value. Hence, similarly to the first embodiment, the processing is simplified and only a small memory is required, and therefore a high-performance microprocessor is not required. As a result, the collision detection apparatus can be constructed with an inexpensive constitution. Further, an improvement in responsiveness can be achieved in comparison with the first embodiment, in which the collision determination is made after waiting for the half period length to be calculated. Furthermore, similarly to the first embodiment, since the sensitivity is corrected in accordance with the half period length of the output of the acceleration sensor 2, effects from the external air temperature and so on are eliminated, and therefore the pedestrian protection device 3 can be activated without a timing delay.

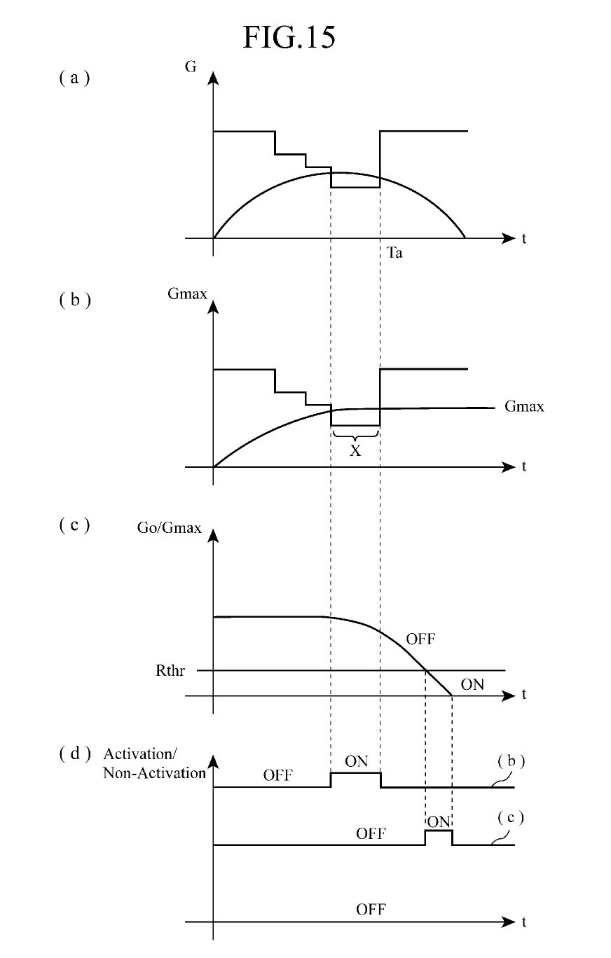

FIG. 15 shows an example of an exceptional processing operation of the collision detection apparatus in accordance with the second embodiment on a temporal axis. As shown in FIG. 15(a), for example, when a threshold map on which the pedestrian protection device 3 is not activated in the region exceeding the half period length Ta is used, a period X in which the threshold Gthr temporarily decreases below the input (the generated G) exceeding Ta occurs, as shown in FIG. 15(b), and in this period activation of the pedestrian protection device 3 must be suppressed.

Hence, as shown in FIGS. 15(c) and 15(d), the collision determination unit 13 suppresses activation of the pedestrian protection device 3 in a case where the comparison between the maximum value Gmax of the acceleration data and the current acceleration G0 indicates that a ratio of G0 to Gmax equals or exceeds a predetermined value (a threshold Rthr).

In other words, by ensuring that the pedestrian protection device 3 is activated only when G0/Gmax is equal to or smaller than the threshold Rthr, activation of the pedestrian protection device 3 can be suppressed relative to G exceeding Ta. Note that when Gmax=0, the collision determination unit 13 cannot perform the G0/Gmax≦Rthr calculation, and therefore, in actuality, the determination is made at G0≦Rthr×Gmax.

As described above, with the collision detection apparatuses in accordance with the first and second embodiments of the present invention, it is possible to provide a collision detection apparatus with which cost-related problems can be solved, a delay in a collision determination timing can be eliminated, and a collision can be determined with a high degree of reliability.

Note that with regard to the collision detection apparatuses in accordance with the first and second embodiments described above, only the pedestrian protection device 3 is illustrated as a collision protection device, but the present invention may be applied similarly to a passenger protection device (an airbag).

Further, the functions of the main ECU 1 (the control unit) shown in FIG. 2 may be realized entirely by software or at least partially by hardware.

For example, the data processing in which the control unit (the main ECU 1) acquires the output of the acceleration sensor 2, performs a collision determination by correcting the sensitivity of the acceleration sensor 2 from a time series of the acquired output of the acceleration sensor 2, and generates a signal for activating the collision protection device (the pedestrian protection device 3) may be realized on a computer by one or a plurality of programs, or at least a part of the processing may be realized by hardware.

### INDUSTRIAL APPLICABILITY

The collision detection apparatus according to the present invention is capable of solving cost-related problems, eliminating a delay in a collision determination timing, and determining a collision with a high degree of reliability, and is therefore suitable for use as a collision detection apparatus or the like that performs a collision determination from an acceleration measured by an acceleration sensor and generates a signal for activating a collision protection device.

1.-7. (canceled)

8. A collision detection apparatus comprising:
an acceleration acquisition processing unit for acquiring an acceleration sensor output;
a duration calculation unit for calculating a duration from a time at which an acquired acceleration passes a preset, predetermined value to a time at which the acceleration passes the predetermined value again; and
a collision determination processing unit for performing a collision determination by comparing the acceleration acquired by the acceleration acquisition processing unit with a threshold,
wherein the collision determination processing unit corrects a sensitivity of the collision determination by modifying the threshold in accordance with the duration calculated by the duration calculation unit, and also performs the collision determination by comparing a maximum value or a minimum value of the acceleration sensor output throughout the duration with the modified threshold.

9. A collision detection apparatus comprising:
an acceleration acquisition processing unit for acquiring an acceleration sensor output;
a duration calculation unit for calculating a duration from a time at which an acquired acceleration passes a preset, predetermined value to a time at which the acceleration passes the predetermined value again; and
a collision determination processing unit for performing a collision determination based on the acceleration acquired by the acceleration acquisition processing unit and a preset threshold,
wherein the collision determination processing unit has a gain correction coefficient for performing a multiplication with the acceleration acquired by the acceleration acquisition processing, corrects a sensitivity of the collision determination by modifying the gain correction coefficient in accordance with the duration calculated by the duration calculation unit, and also performs the collision determination by comparing a value, obtained by multiplying a maximum value or a minimum value of the acceleration sensor output throughout the duration by the gain correction coefficient, with the preset threshold.

10. The collision detection apparatus according to claim 8, wherein the duration calculation unit calculates a half period of the acceleration sensor output.

11. The collision detection apparatus according to claim 9, wherein the duration calculation unit calculates a half period of the acceleration sensor output.

12. The collision detection apparatus according to claim 8, wherein the collision determination processing unit corrects the sensitivity of the collision determination by modifying the threshold to a small value when the duration calculated by the duration calculation unit is long and modifying the threshold to a large value when the duration is short.

13. The collision detection apparatus according to claim 9, wherein the collision determination processing unit corrects the sensitivity of the collision determination by modifying the gain correction coefficient to a large value when the duration calculated by the duration calculation unit is long and modifying the gain correction coefficient to a small value when the duration is short.

14. The collision detection apparatus according to claim 8, wherein the collision determination processing unit performs the collision determination successively from a time at which the acceleration serving as the acceleration sensor output exceeds the predetermined value, and wherein the collision determination processing unit compares the maximum value or the minimum value of the acceleration sensor output with the acquired acceleration sensor output, and when the acquired acceleration sensor output exceeds a predetermined ratio with respect to the maximum value or the minimum value, the collision determination processing unit suppresses generation of a signal for activating a collision protection device even if the maximum value or the minimum value of the acceleration sensor output exceeds the threshold.

15. The collision detection apparatus according to claim 9, wherein the collision determination processing unit performs the collision determination successively from a time at which the acceleration serving as the acceleration sensor output exceeds the predetermined value, and wherein the collision determination processing unit compares the maximum value or the minimum value of the acceleration sensor output with the acquired acceleration sensor output, and when the acquired acceleration sensor output exceeds a predetermined ratio with respect to the maximum value or the minimum value, the collision determination processing unit suppresses generation of a signal for activating a collision protection device, even if a value obtained by multiplying the maximum value or the minimum value of the acceleration sensor output by the gain correction coefficient exceeds the threshold.
